(19) United States
(12) Patent Application Publication
(10) Pub. No.: US 2011/0303503 A1
(43) Pub. Date: Dec. 15, 2011

(54) Damping Device for Flat Components

(76) Inventor: Nicolas Merlette, Suilly la Tour (FR)

(21) Appl. No.: 13/216,674

(22) Filed: Aug. 24, 2011

Related U.S. Application Data
(63) Continuation of application No. PCT/EP2009/065988, filed on Nov. 27, 2009.

(30) Foreign Application Priority Data
Feb. 26, 2009 (DE) 10 2009 010 439.9

(51) Int. Cl. F16F 7/10

(52) U.S. Cl. 188/378

(57) ABSTRACT

The invention relates to a device (100, 110) for reducing vibrations and/or oscillations in flat components (201, 202) of vehicles, comprising a carrier (101, 111), a damping means (102, 112) disposed on the carrier (101, 111) for reducing the vibrations and/or oscillations, wherein a plurality of damping means (102, 112) are provided on the carrier (101, 111) in order to capture a plurality of vibration and/or oscillation zones of the flat components (201, 202).

The invention is in the field of sound-damping apparatuses for planar components.

Very thin-walled panels are used almost exclusively nowadays in the manufacture of vehicles, machinery, and appliances. Mechanically moving parts or operating motors unavoidably impart to these thin-walled panels vibrations that are in many cases within the audible range of the human ear. These vibrations are propagated in the form of solid-borne sound throughout the vehicle or machine or appliance, and at remote locations can be radiated into the air as unpleasant noise. In order to reduce acoustic radiation and solid-borne sound damping these panels are therefore, especially in automobile construction and in the manufacture of household appliances, often equipped with sound-damping linings (called “anti-drum” coatings).

One skilled in this sector of the art makes a strict distinction between sound damping and sound insulation. In sound damping, the acoustic vibrational energy is converted into other forms of energy, for example heat. In sound insulation, the passage of longitudinal vibrations (sound) is diminished by way of a barrier. This is also done, for example, by reflection of the sound.

Numerous procedures are already known for the purpose of sound damping. According to a conventional procedure, mixtures of fillers having a high specific weight and bitumen are extruded into films from which the corresponding shaped parts are then stamped or cut. These films are then adhesively bonded onto the relevant panel parts; they may also need to be adapted to the shape of the panel by heating. Although these bitumen films are still frequently used because of their low material cost, they are very brittle and furthermore tend to spall off from the panel, especially at low temperatures. Even the addition of elastomers, as often proposed, produces only a slight improvement that is insufficient for many applications. In addition, application of the pre-shaped bitumen parts onto intricately shaped or poorly accessible panel parts of machines or vehicles, for example the inner surfaces of the cavities of motor vehicle doors, is not possible at all. A further disadvantage is that in many cases several stamped parts are necessary for a single vehicle or appliance, requiring complex stocking.

The applicant's German Application DE 10 2005 003 057 A1 discloses rubber compounds that have a low viscosity at room temperature or at only slightly elevated temperatures, so that they can be applied onto motor vehicle bodies-in-white using spray application equipment, and after hardening can produce acoustic damping. The preparations recited therein are suitable for numerous special uses. They require a vulcanization step for curing, however, which requires that baking conditions be precisely adhered to.

U.S. Pat. No. 6,135,541 A discloses a door of a motor vehicle, comprising a reinforcing component that guarantees side impact protection, on which are provided, for the damping of acoustic vibrations, damping elements that comprise an impact-damping adhesive and are in contact with the outer panel of the door in order to damp acoustic vibrations. The high level of assembly complexity when using many damping elements is disadvantageous here. In addition, the region capable of being damped is confined to the region of the side impact protector for installation of the damping elements.

An object of the present invention is therefore to make available an improved sound-damping apparatus.

This object is achieved by the features of Claim 1.

The advantageous embodiments of the invention are indicated by way of the dependent claims.

The basic idea of the invention is to use an apparatus for reducing oscillations and/or vibrations and/or noise on preferably planar, in particular flat or curved components, for example of vehicles, which apparatus comprises a carrier, a damping means provided on the carrier for reducing the oscillations and/or noise and/or vibrations, a plurality of damping means being provided on the carrier in order to cover multiple oscillation and/or noise and/or vibration zones, hereinafter referred to simply as “vibration zones,” of the planar components. When the apparatus is used in a vehicle, the oscillation and/or vibration source would be, for example, the vehicle's engine, whereas the vibration zone would be located on a thin-walled panel caused to vibrate, for example, by the engine, at which panel the vibration is radiated into the air as unpleasant sound.

The use of such an apparatus provides many advantages. By equipping a carrier with a damping means at a plurality of regions, it is possible to influence multiple vibration zones of a planar component by means of one carrier. This ensures, in particular, economical assembly, since only one apparatus having a carrier, with which apparatus multiple vibration zones can be influenced, needs to be installed. The shape of the carrier is preferably adapted to the zones of the planar component that are to be influenced, and is equipped in the region of the zones with the damping means or a damping material.

Suitable carriers can be produced, in particular, from a metallic material. Carriers made of aluminum are also conceivable. A plastic material is, however, used. The carrier can be produced in particular from polyamide and/or nylon.

Expandable materials, very particularly preferably thermally expandable materials, are preferably used as a damping means or damping material.

Suitable as planar components to be damped are, in particular, all internal and external panels of a vehicle, for example a door panel, engine compartment hood, trunk lid, vehicle roof, floor panel, fender, A-pillar, B-pillar, C-pillar, and/or sill. The apparatus according to the present invention can of course also be used to damp planar components in aviation or in mechanical or industrial engineering.

A further advantage is that the carrier is equipped with the damping means on the side of the carrier facing toward the planar component. It is thereby possible to ensure that the damping means comes securely into contact with the planar component. In the case in which an expandable damping means is used, this manner of equipping the carrier predefines an expansion direction of the damping means, specifically in the direction of the planar component to be damped.

A further advantage is that the carrier for an apparatus according to the present invention is manufactured from a metallic material; conceivable in this case, in particular, is a material or material group from which the planar component, or another component on which the carrier is fastened, is configured. It is thereby possible to avoid contact corrosion between the components. In addition, production of the planar component and the carrier from one material simplifies disposal. Furthermore, the use of a metallic material for the carrier can offer advantages in terms of strength. The carrier can be configured, for example, so that it reinforces the planar component and thus, along with the carrier function for the damping means, additionally makes available a strengthening structural effect.

Alternatively, it can be advantageous to manufacture the carrier from a plastic material. It is particularly advantageous in this context to use a thermoplastic. This can, in particular, simplify manufacture of such a carrier. A carrier of this kind can, for example, be economically manufactured by injection molding. In addition, a particularly lightweight carrier can be made available by the use of a plastic material. The use of a plastic material can also have a positive effect on the corrosion resistance of the apparatus. The use of a polyamide, in particular PA-6,6, has proven particularly advantageous as a material for the carrier.

A further advantage is application of the damping means onto the carrier by means of an injection molding method. The damping means is in this context preferably made of an expandable material that is injection-molded onto the carrier, made of a metallic material or a plastic material, during an injection molding operation. In order to save time and cost, preferably all the damping means of the carrier are applied in one injection molding operation. Thanks to the use of an injection molding method to apply the damping means, the latter can be applied precisely onto the intended locations of the carrier. In addition, metering of the quantity of damping material is easier, so that not too much material is applied (which would increase costs) or too little material (which would result in decreased damping of the planar component).

Manufacture of the apparatus by means of a part-joining injection molding method and/or bi-injection molding method has proven particular advantageous for manufacturing the carrier from a plastic material. In a first step, the carrier itself, with possible connecting means for positional immobilization and/or optionally further constituent features, can be manufactured by injecting a thermoplastic material, in particular a polyamide, into an injection mold. The two halves of the injection mold are then pulled apart for unmolding. A plurality of damping means, in particular made of a thermally expandable material, can then be applied in a second suitable injection mold in a second working step. With this kind of (preferably entirely automated) manufacturing method for an apparatus according to the present invention, an apparatus designed exactly for the planar component to be damped can be made available with small production tolerances.

A further advantage is the use of a thermally expandable material as a damping means or damping material. Suitable basic polymeric binding agents can be used, in particular, in this context, for example ethylene-vinyl acetate copolymers (EVA), copolymers of ethylene with (meth)acrylate esters that may optionally also contain portions of polymerized-in (meth)acrylic acid, statistical or block copolymers of styrene with butadiene or isoprene or hydrogenation products thereof. The latter can also be tri-block copolymers of the SBS or SIS type, or their hydrogenation products SEES or SEPS. In addition, the binding agents can also contain crosslinking agents, adhesion promoters, tackifying resins, plasticizers, and further adjuvants and additives, for example low-molecular-weight oligomers. In order to achieve sufficient propellant capability and expandability, these polymeric binding agents also contain propellants. All known propellants are suitable in principle as a propellant, for example the “chemical propellants” that release gases by decomposition, or “physical propellants,” i.e. expanding hollow spheres. Examples of the former propellants are azobisisobutyronitrile, azodicarbonamide, di-nitrosopentamethylenetetramine, 4,4′-oxybis(benzenesulfonic acid hydrazide), diphenylsulfone-3,3′-disulfohydrazide, benzene-1,3-disulfohydrazide, p-toluenesulfonyl semicarbazide. Examples of the physical propellants are expandable hollow plastic microspheres based on polyvinylidene chloride copolymers or acrylonitrile-(meth)acrylate copolymers, such as those commercially obtainable under the names “Dualite” and “Expancel” from the Pierce & Stevens and Casco Nobel companies, respectively.

It is particularly suitable to use as a damping means a damping material as described in International Patent Application PCT/EP2007/008141. Regarding aspects relevant to the damping material, the reader may refer to the aforesaid document whose disclosure content supplements, to that extent, the disclosure of the present patent application.

Activation and expansion of the expandable material can preferably be accomplished utilizing the process heat of a cathodic dip oven for curing the cathodic dip coating of, for example, a motor vehicle body. Separate application of heat in order to expand the expandable material is, of course, also conceivable. In this context, the carrier defines the location of the damping means at the vibration zone prior to immobilization upon expansion. For this, the carrier is preferably fixedly connected to the planar component or to another component.

A further advantage is that the carrier is equipped with fastening means for establishing the location of the apparatus relative to the component to be damped. Provision can be made here for fastening the carrier to the component itself, or to a further component that is directly or indirectly connected to the component to be damped. When the apparatus is used to damp an outer panel of a vehicle door, for example, the carrier can be provided in particular on a stiffening or reinforcing component, for example a side impact protector, the carrier being equipped with corresponding fastening means. The fastening means are preferably injection-molded on during manufacture of the carrier from a plastic material. In particular, clips or clamps that can engage into corresponding receptacles at the installation location are used. Also conceivable is equipping the carrier using fastening elements in the form of openings, in order to immobilize the carrier at the installation location by way of corresponding projecting fastening elements.

A further advantage is that the carrier is manufactured from multiple carrier parts that are joined to one another prior to assembly at the installation location of the apparatus. A configuration of this kind has advantages especially when the carrier or the damping means has a complex shape. The carrier parts can, for example, be individually fitted with one or more damping means, whereupon the carrier parts equipped with the damping means are joined in order to make the carrier available. The manufacture of multiple carrier parts may prove useful in particular when the carrier and/or damping means is manufactured by means of an injection molding method, for example because undercuts or other possible special features of the carrier and/or damping means may, for example, be difficult to implement in terms of injection molding technology.

A further advantage is that the carrier is equipped with openings or holes in the regions provided for the damping means. The openings ensure secure immobilization of the damping means on the carrier. For example, the damping means can be injection molded onto the carrier in such a way that the material to be damped travels locally into the openings, so that mechanical fastening can be made available. In the case where an expandable material is used as a damping means, it can expand through the opening upon expansion so as to ensure additional fastening on the damping means on the carrier after expansion. This fastening can have advantages in particular in the case of an additional reinforcing function for the carrier, since in this fashion, of the forces acting on the surface to be damped by the damping means can be transferred via the damping means to the carrier.

Several particularly preferred embodiments of the invention will now be explained in further detail with reference to the drawings.

Specifically:

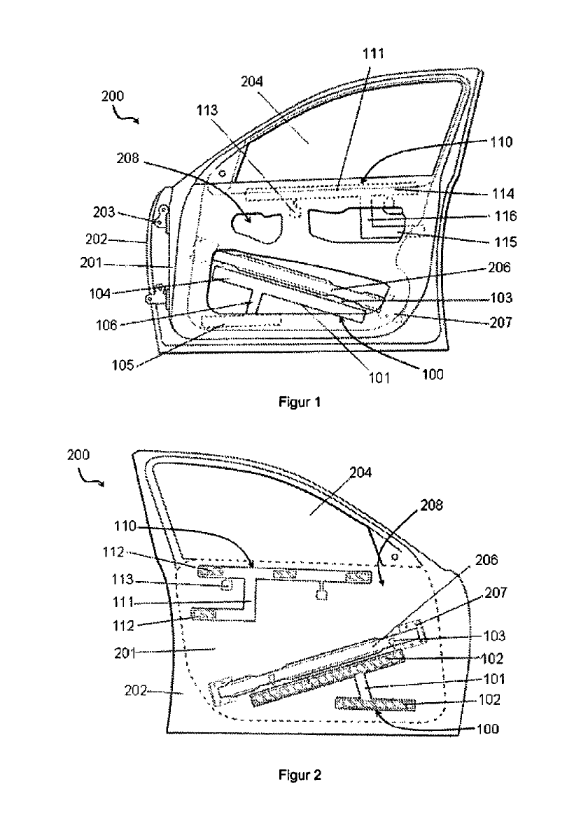

FIG. 1 is a side view of the inner side of a motor vehicle door, having apparatuses according to the present invention that are used to damp the outer panel,

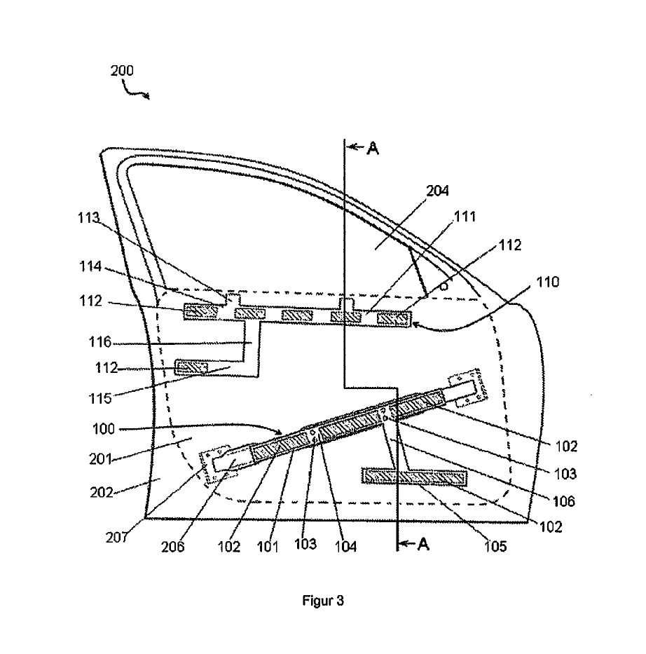

FIG. 2 is a partly sectioned side view of the outer side of the motor vehicle door of FIG. 1,

FIG. 3 is a partly sectioned side view of the outer side of a motor vehicle door having an alternative embodiment of apparatuses according to the present invention that are used to damp the outer panel,

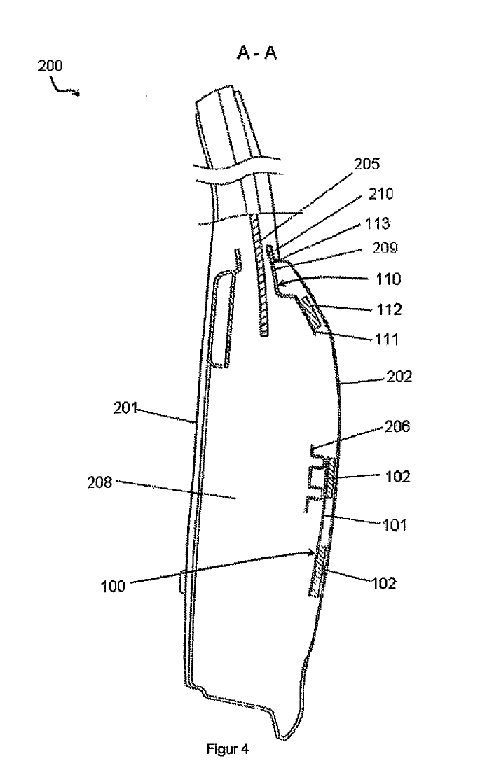

FIG. 4 is a sectioned view, along A-A, through the motor vehicle door of FIG. 3,

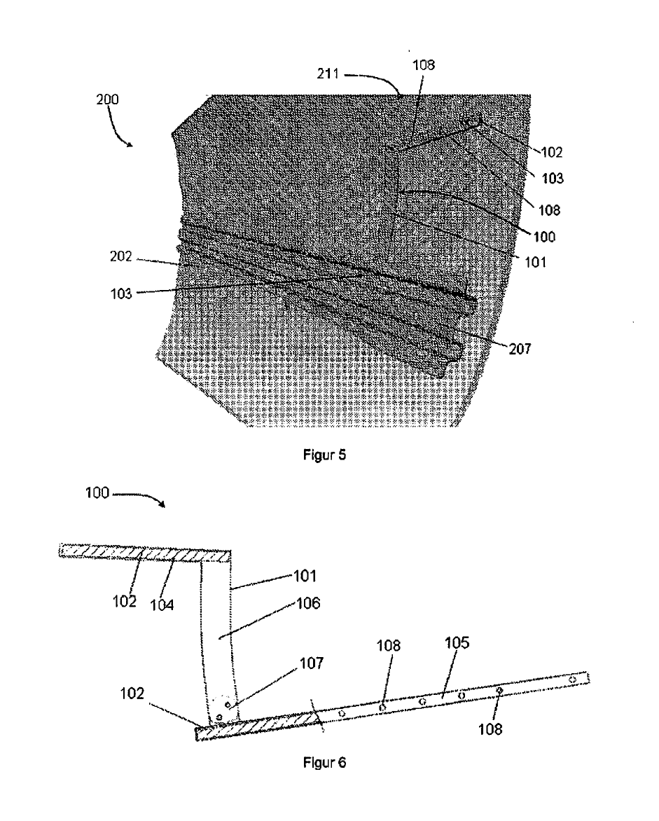

FIG. 5 is a partial view, in perspective, of a motor vehicle door having a further alternative of an apparatus according to the present invention that is used to damp the outer panel,

FIG. 6 is a partly sectioned side view of the apparatus according to the present invention of FIG. 5.

FIG. 1 is a side view of an inner side of a motor vehicle door 200 that is equipped with apparatuses 100, 110 according to the present invention. Motor vehicle door 200 comprises, as a planar component, an inner panel 201 that is connected to a further planar component (an outer panel 202). Outer panel 202 represents part of the outer surface of the vehicle. Door 200 is connected via hinges 203 to the body of the vehicle. Door 200 further comprises a window opening 208 in which a window (not shown) is provided. Inner panel 201 and outer panel 202 partially surround a cavity 208. Arranged inside cavity 208 is a reinforcing component 206 that, in the present exemplifying embodiment, is installed via fastening elements 207 on inner panel 201 and enhances the stability and strength of door 200 and, in particular, provides side impact protection for door 200. Reinforcing component 206 extends obliquely inside cavity 208 from the side of door 200 at which hinges 203 are provided, at approximately half the height of cavity 208, to the opposite side of door 200 in the lower region of cavity 208.

Outer panel 202 and the inner panel are made of thin-walled panels to which vibrations that can lie within the range of the human ear can be imparted by moving parts of the vehicle or by an operating engine. These vibrations can be radiated into the air as unpleasant noise, so that two apparatuses 100, 110 for damping the vibrations are provided inside cavity 208 at a vibration zone and/or oscillation zone. The one apparatus 100 is provided in cavity 208 below reinforcing component 206. The second apparatus 110 is provided inside cavity 208 below window opening 204. Apparatus 100 comprises a carrier 101 made of a plastic material, in the present case of polyamide-6,6. Carrier 101 is made up of an upper carrier region 104 that extends parallel to reinforcing component 206 inside cavity 208. Fastening means 103, with which carrier 101 is fastened onto reinforcing component 206 of door 200, are shaped onto upper carrier region 104. Protruding from upper carrier region 104 is a connecting carrier piece 106 onto which a lower carrier region 105 is shaped. Carrier 101 thus contains lower carrier region 105, connecting carrier piece 106, and upper carrier region 104 having the shaped-on fastening means 103. Damping means (not shown), which absorb the vibrations of outer panel 202 and preferably convert them into heat, are provided on carrier 101.

Below window opening 204, second apparatus 110 is provided with a carrier 111 that extends, with an upper carrier region 114, substantially parallel to the underside of a frame delimiting window opening 204. Carrier 111 further comprises a connecting carrier piece 116 protruding at an angle from upper carrier region 114, as well as a lower carrier region 115 that extends into the region of the door opening apparatus (not shown). Carrier 111 is equipped with fastening means 113 with which carrier 111 is fastened onto outer panel 202. In addition, carrier 111 comprises damping means (not shown) that serve to damp the vibrations of outer panel 202. Damping means 102, 112 of apparatuses 100, 110 can of course also be used to damp inner panel 201. Also conceivable is a utilization of apparatuses 100, 110 for other planar components of a motor vehicle, in the particular of the engine compartment hood, roof, trunk lid, fenders, other doors, a floor panel, and/or a sill.

FIG. 2 is a partly sectioned side view of the outer side of motor vehicle door 200 of FIG. 1. In the present view, the surface of outer panel 202 that partly delimits cavity 208 has been omitted for better clarity. Visible through the omitted region of outer panel 202 is reinforcing component 206, which is installed via fastening elements 207 onto inner panel 201 and extends obliquely inside cavity 208. Carrier 101 is connected to reinforcing component 206 via fastening means 113. Fastening means 103 can be configured as clips or clamps that preferably coact with corresponding receptacles on reinforcing component 206. An adhesive connection of carrier 101 to reinforcing component 206 is, of course, also conceivable. Carrier 101 is equipped with two damping means 102, first damping means 102 being provided on upper carrier region 104 and second damping means 102 on lower carrier region 105. A subdivision of damping region 102 into individual segments, in order to effect targeted damping and to economize on material, is of course possible. Second apparatus 210, which is adhesively bonded via fastening means 113 preferably onto outer panel 202, is provided below window opening 204. Second apparatus 110 comprises multiple damping means 112 which influence multiple vibration zones of outer panel 202.

In the present exemplifying embodiment, damping means 102, 112 that are used involve a thermally expanded material, in particular a material such as that described in Patent Application PCT/EP2007/008141, the disclosure content of which supplements, to that extent, the present disclosure. Activation and expansion of the expandable material occur preferably by utilizing the process heat of a cathodic dip oven for curing the preferably cathodic dip coating of the vehicle body, and thus also of vehicle door 200. It is thereby possible to eliminate a method step and thus to save time and cost, since the process heat of a method that is performed anyway is utilized in order to expand the expandable material. In the expanded state, damping means 102 112 adhere to the component to be damped (outer panel 202 in the present exemplifying embodiment) and absorb the vibrations of outer panel 202 and convert them preferably into heat. Carriers 101, 111 thus serve chiefly as an assembly aid and immobilization capability for damping means 102, 112. Carriers 101, 111 also can additionally be configured so that they produce a reinforcing effect on, in particular, outer panel 202.

FIG. 3 is a partly sectioned side view of the outer side of a motor vehicle door 200 having alternative embodiments of apparatuses 100, 110 according to the present invention that are used to damp outer panel 202. The surface of outer panel 202 that partly delimits cavity 208 has been omitted for better clarity. Inner panel 201 is visible through the omitted part of outer panel 202. Door 200 comprises reinforcing component 206, connected on both sides to inner panel 201 via fastening elements 207, which extends obliquely inside cavity 208. Provided on reinforcing component 207, on the side thereof facing toward outer panel 202, is apparatus 100 according to the present invention having carrier 101, which latter is connected via fastening means 103 to reinforcing component 206. Carrier 101 is made up of upper carrier region 104 and lower carrier region 105, which is connected to upper carrier region 104 via a connecting carrier piece 206. Apparatus 100 is connected via upper carrier region 104, by way of the said fastening means 103, to reinforcing component 206. Upper carrier region 204 extends onto reinforcing component 206, and is thus arranged at least in part between reinforcing component 206 and outer shell 202. Lower carrier region 105 serves to cover and to act upon a further vibration zone of outer panel 202 below reinforcing component 206. Provided on carrier 101 of apparatus 100 are multiple damping means 102 made of a thermally expandable material which, after expansion, come into contact with and, for example, adhere to the inner wall of outer panel 202 in order to achieve damping of vibrations of outer panel 202.

In this exemplifying embodiment as well, door 200 comprises a second apparatus 110 above first apparatus 100 below window opening 204. Carrier 111 of second apparatus 110 comprises an upper carrier region 114 as well as a lower carrier region 115 that is connected via a connecting carrier piece 116 to upper carrier region 114. Carrier 111 is connected at upper carrier region 114, via shaped-on fastening means 113, to outer panel 202. In the present exemplifying embodiment, fastening means 113 are configured as projecting surface regions of carrier 111 that are gripped between a canted-out segment of outer panel 202. Fastening of apparatus 110 onto inner panel 201 is of course also conceivable. Multiple damping means 112, which here as well are made of a thermally expandable material and are provided in order to damp outer panel 202, are provided on carrier 111 of second apparatus 110. Both apparatuses 100, 110 can of course also be provided for the damping of inner panel 201. It is furthermore conceivable for damping means 102, 112 to be made of different materials. It is conceivable in particular for a portion of damping means 102, 112 to be made available from, for example, a thermally expandable material, and another portion in turn from, for example, a bitumen.

FIG. 4 is a sectioned view, along line A-A, through motor vehicle door 200 of FIG. 3. Apparatus 100 for damping outer panel 202 is provided on reinforcing component 206 which extends substantially through cavity 208 enclosed by inner panel 201 and outer panel 202. Said apparatus is arranged between reinforcing component 206 and the inner wall of outer panel 202. Carrier 101 of apparatus 100 is connected to reinforcing component 206 via fastening means (not depicted) in order to establish the position of apparatus 100. Provided on the side of carrier 101 facing toward the inner wall of outer panel 202, as damping means 102, is an expandable material that, after expansion, comes into contact with the inner wall of outer panel 202. Carrier 101 comprises a protruding region on which is provided a further damping means 102 that serves to influence a further vibration zone of outer panel 202. Further damping means 102 is no longer arranged in the region of reinforcing component 206. As a result of the fastening of carrier 101 to reinforcing component 206, it is thus possible to influence multiple vibration zones by means of a single apparatus 100. This creates advantages especially in terms of assembly, since only one apparatus 100 needs to be connected, for example, to reinforcing component 206 in order to cover multiple vibration zones.

Depicted in the upper region of door 200 is a window 205 with which the window opening (not depicted) can be closed off. Provided at a distance from window 205 is a window guide 209 that projects into cavity 208. Window guide 209 is connected to outer panel 202 at a canted-out edge 210 of outer panel 202. Window guide 209 is, in that context, gripped between the canted-out region and thus immobilized by a frictionally engaged connection. In the present exemplifying embodiment, window guide 209 is configured as part of the second damping apparatus 110. This refers to the planar fastening means 113, projecting from carrier 111, with which carrier 111 is connected to outer panel 202. Here as well, the connection provides positional immobilization of carrier 11 with damping means 112 provided thereon. Damping means 112 is provided on the side of carrier 111 facing toward the inner wall of outer panel 202. In addition, carrier 111 comprises further damping means 102 (not evident in the sectioned view, or omitted for the sake of better clarity) in order to cover multiple vibration zones with second apparatus 110.

FIG. 5 is a perspective view of a motor vehicle door 200 having a further alternative of an apparatus 100 according to the present invention that is used to damp outer panel 202 of door 200. In the exemplifying embodiment shown, the inner panel of door 200 has been omitted for better clarity. Door 200 comprises reinforcing component 206, which contains openings. Apparatus 100, arranged partly between reinforcing component 206 and the inner wall of outer panel 202, comprises, on carrier 101, projecting fastening means 103 in the form of snap connection means, which can be brought into engagement with the openings provided in reinforcing component 206 in order to make available a connection between reinforcing component 206 and apparatus 100 and, in particular, to define the location of damping means 102, arranged on apparatus 100, relative to outer shell 202 that is to be damped. Damping means 102 are arranged between carrier 101 and the inner wall of outer panel 202. In this region, carrier 101 extends substantially and at least locally parallel to reinforcing component 206. Carrier 101 furthermore comprises a part, protruding at an angle, that provides a connection to a further part of carrier 101 that is provided for reception of a further damping means 102. This second region is arranged below a door handle recess 211 of door 200. Damping means 102 is provided in this region, once again, on the side facing toward the inner wall of outer panel 202. Said openings 108 of carrier 101 are evident in this region of carrier 101. These openings 108 are also located in the other regions of carrier 101 that are equipped with damping means 102. Damping means 102 (an expandable material in the present exemplifying embodiment) can expand through openings 108 upon expansion, thus achieving immobilization and/or adhesive bonding of carrier 101 on or onto damping means 102 and/or the inner wall of outer shell 202 and/or reinforcing component 206. It is thereby possible, especially in the case of a conceivable configuration of carrier 101 as a structurally reinforcing component, to achieve additional reinforcement of outer panel 202. In addition, further fastening means 103 are provided on the part of carrier 101 provided below door handle recess 211. These can be used for further fastening of apparatus 100 to further components of door 200. A further damping apparatus can also be connected to apparatus 100 that is shown, in order to cover further vibration zones.

FIG. 6 is a partly sectioned side view of apparatus 100 according to the present invention of FIG. 5. Apparatus 100 comprises carrier 101 made of a thermoplastic material. Carrier 101 contains upper carrier region 104 that serves to receive damping means 102 made of an expandable material. Concealed fastening means for fastening apparatus 100 onto a component, for example onto a motor vehicle door, are provided on the back side of upper carrier region 104. A connecting carrier piece 106 protruding at an angle is provided on upper carrier region 104. This piece can be equipped with a further damping means. Connecting carrier piece 106 connects upper carrier region 104 to a lower carrier region 105 that in turn protrudes at an angle from connecting carrier piece 106 but, in the present exemplifying embodiment, is oriented in approximately the opposite direction from upper carrier region 104. Upper carrier region 104, connecting carrier piece 106, and lower carrier region 105 together constitute carrier 101 of apparatus 100. Lower carrier region 105 is in turn equipped with a further damping means 102. Visible in the partly sectioned view, in which damping means 102 of lower carrier region 105 has been partly omitted, are openings 108 of carrier 101 through which damping means 102 can expand. Upper carrier region 104 can also have similar openings 108. In the present exemplifying embodiment, apparatus 100 is manufactured by means of a bi-injection molding method. Upper carrier region 104, having the shaped-on connecting carrier piece 106 and damping means 102, is manufactured in a separate manufacturing step from lower carrier region 105 having second damping means 102. Upper carrier region 104 is then connected, with connecting carrier piece 106, to lower carrier region 106 in order to produce carrier 101 and apparatus 100. For this purpose, connecting means 107 are shaped onto connecting carrier piece 106, and corresponding receptacles for connecting means 107 are shaped onto lower carrier region 105. These can be, in particular, clip-type or snap-type connecting elements that are sufficiently familiar to one skilled in the art.

In order to manufacture a carrier part 104, 105 of carrier 101, in a first step carrier part 104, 105 itself, having possible connecting means 107 for positional immobilization and/or optionally further constituent features (for example, openings 108) is manufactured by injecting a thermoplastic material into an injection mold. The two halves of the injection mold are then pulled apart for unmolding. In a second working step, damping means 102 can then be applied by injection in a second suitable injection mold in a second injection molding operation.
100 Apparatus
101 Carrier
102 Damping means
103 Fastening means
104 Upper carrier region
105 Lower carrier region
106 Connecting carrier piece
107 Connecting means
108 Opening
110 Second apparatus
111 Carrier
112 Damping means
113 Fastening means
114 Upper carrier region
115 Lower carrier region
116 Connecting carrier piece
200 Vehicle door
201 Inner panel
202 Outer panel
203 Hinge
204 Window opening
205 Window
206 Reinforcing component
207 Fastening element
208 Cavity
209 Window guide
210 Canted-out edge
211 Door handle recess

1. An apparatus (100, 110) for reducing oscillations and/or vibrations on components (201, 202) of vehicles, comprising a carrier (101, 111), a damping means (102, 112) provided on the carrier (101, 111) for reducing the oscillations and/or vibrations, wherein a plurality of damping means (102, 112) are provided on the carrier (101,111) in order to cover multiple oscillation zones and/or vibrations zones of the components (201, 202).

2. The apparatus (100,110) according to claim 1, wherein the damping means (102,112) are provided on the side of the carrier (101,111) facing toward the component (201, 202).

3.-10. (canceled)
